(19) United States
(12) Patent Application Publication
(10) Pub. No.: US 2012/0172154 A1
(43) Pub. Date: Jul. 5, 2012

(54) BALL TRAINING APPARATUS

(75) Inventor: BILL ICIM, OXENFORD (AU)

(73) Assignee: JENELLE LORETTE ARNOTT, MacGregor (AU)

(21) Appl. No.: 13/343,711

(22) Filed: Jan. 5, 2012

(30) Foreign Application Priority Data
Jan. 5, 2011 (AU) AU2011100019

(51) Int. Cl. A63B 69/00; B23P 11/00

(52) U.S. Cl. 473/423; 29/525.01

(57) ABSTRACT

A ball training apparatus includes an elastic cord. A fastener is capable of being at least partially received between a bladder and a sheath of an inflatable ball, the fastener being configured to permit an end of the elastic cord to be attached to the fastener. The elastic cord is configured so that, when the ball is struck, the ball is capable of sufficient travel for a user to observe the flight of the ball and of returning to a position in which retrieval of the ball is facilitated.

### PRIORITY CLAIM

This application claims priority to Australian Innovation Patent Application Serial No: 2011100019, inventor Bill Icim, entitled “A BALL TRAINING APPARATUS”.

### FIELD OF THE INVENTION

This invention relates to a ball training apparatus.

### BACKGROUND OF THE INVENTION

It is generally understood that training with a ball requires a significant amount of repetition. It follows that the number or repetitions within a time period is reduced if a person has to fetch the ball. Also the space within which the person wishes to train may be limited so that full flight of the ball is not possible.

A problem with a number of presently available training apparatus of the type having a ball fastened to a cord is that they require a specialized or modified ball. Alternatively, the manner in which the cord is fastened to the ball can interfere with the action of kicking or otherwise striking the ball.

### SUMMARY OF THE INVENTION

An embodiment or example of a ball training apparatus comprises
a. an elastic cord; and
b. a fastener capable of being at least partially received between a bladder and a sheath of an inflatable ball, the fastener being configured to permit an end of the elastic cord to be attached to the fastener, the elastic cord being configured so that, when the ball is struck, the ball is capable of sufficient travel for a user to observe the flight of the ball and of returning to a position in which retrieval of the ball is facilitated.

The fastener may include a stop that is elongated and hinged to define two portions that are capable of pivoting towards each other to reduce a plan profile of the stop to facilitate insertion of the stop through an opening in the sheath so that subsequent pivoting away from each other serves to resist extraction of the stop from the opening.

The fastener may include a connector attached to the stop at a position about halfway along the length of the stop and between said portions, the connector extending through the opening in the sheath for connection to the cord.

The connector may be a swivel connector so that twisting of the cord and subsequent entanglement resulting from rotation of the ball relative to the cord is reduced. The swivel connector may include a pivot pin that extends from the stop, a looped connector being mounted on the pivot pin and rotatable with respect to the pivot pin. The stop may be configured so that, when the bladder is inflated, the portions of the stop are driven apart further to secure the stop between the bladder and the sheath.

The ball training may include an anchor for use on a support surface, the anchor being formed from a material affording the anchor a weight and surface property so as to resist displacement of the anchor relative to the support surface within a stretching threshold of the elastic chord.

The ball training apparatus may include an anchoring accessory for anchoring the anchor to a substrate. The anchoring accessory may be an auger tool having a handle and a stem extending from the handle, a free end of the stem being sharpened so that the stem is able to be inserted into the substrate, an auger formation being arranged on the stem so that the stem can be screwed into the substrate.

The anchor may define an opening through which the stem of the auger can be passed prior to screwing the stem into the substrate. The anchor may include a base with an opening through which the end of the cord can be threaded to allow the cord to be tied to the base and a cord-retaining formation to facilitate winding of the cord onto the base.

The base may define a kicking ball support formation so that the ball can be supported in a kicking position on the base. Instead, or in addition, a strike ball support may be mountable on the base for supporting a ball at a suitable height for striking.

An embodiment or example of a ball training apparatus comprises
a. an inflatable ball having an inflatable bladder located within a sheath;
b. an elastic cord; and
c. a fastener at least partially received between the bladder and the sheath, an end of the elastic cord attached to the fastener, the elastic cord being configured so that, when the ball is struck, the ball is capable of sufficient travel for a user to observe the flight of the ball and of returning to a position in which retrieval of the ball is facilitated.

There is also provided a method of fastening an elastic cord to an inflatable ball having an inflatable bladder located with a sheath, the method including the steps of
a. forming an opening in the sheath;
b. inserting a fastener at least partially through the opening;
c. attaching the elastic cord to the fastener; and
d. inflating the bladder.

There is provided a ball training apparatus comprising
a. an anchor;
b. a ball;
c. an elastic cord with one end of the elastic cord fast with the anchor; and
d. a fastener for fastening the ball to another end of the cord, the elastic cord being configured so that, when the ball is struck, the ball is capable of sufficient travel for a user to observe the flight of the ball and of returning to a position in which retrieval of the ball is facilitated.

The ball may be of the type having an outer sheath and an inflatable inner bladder.

The fastener may include an anchor member or stop that is capable of being received between the sheath and the inner bladder, and the cord may be fastened to the stop so that the cord is attached to the ball.

The stop may be elongated and may have a transverse hinge so as to form two foldable portions that are capable of being folded relative to each other to reduce a plan profile of the stop.

The stop may define an opening at the transverse hinge. In one embodiment, an end of the cord may be passed through the opening and knotted so that the end is inhibited from being pulled back through the opening. It follows that the knot can initially be pulled away from the opening to allow the stop to be folded such that the knot does not interfere with the stop. The stop can thus be folded to reduce its plan profile.

The outer sheath of the ball may define an opening, and the stop and the knot may be shaped and sized so that the stop, when folded, and the knot can be pushed through the opening in the outer sheath of the ball, so that when the cord is pulled, the knot is received between the folded portions of the stop to drive the folded portions apart, so as to increase the plan profile of the stop. This serves to retain the stop between the inner bladder and the sheath. Instead, or in addition, a stopper may be attached to the end of the chord to inhibit the chord from being pulled back through the opening in the stop.

The ball may be of the type having a relatively solid core, such as a cricket ball or baseball. Thus, the fastener may include an anchor member in the form of a plug having an external self-tapping thread capable of allowing the plug to be screwed into the solid core of the ball. The plug may be tubular and an end of the cord may be passed through the plug and knotted so that the end is inhibited from being retracted from the plug.

The plug may include an inner plug member and an outer plug member that are retained relative to each other in a manner that permits swiveling relative to each other. The cord may be passed through the inner plug member and knotted so that the end is inhibited from being retracted from the inner plug member.

Instead of the cord being fastened directly to the stop, the fastener may include a loop that is connected to the stop. This allows the cord to be fastened to the loop and unfastened, when necessary. Thus, the ball training apparatus may include a number of different types of balls that are interchangeable.

The loop may be formed from a string, and ends of the string may be passed through the opening of the stop and knotted to inhibit the loop from being pulled through the stop. The string may include a flexible member and a plurality of spaced apart formations on the string, for example a beaded string.

The elastic cord may be formed from latex or rubber. The latex may be natural or synthetic. The elastic cord may be in the form of a tubular elastic cord. In one example, the tubular elastic cord may have an outer diameter of between approximately 2 mm and 6 mm and an inner diameter of between approximately 1 mm and 5 mm. Also, the cord may be between 4 m and 10 m long. However, it will be appreciated that this length can vary depending on the application. Also, the cord can be longer in those examples in which the effective length of the cord is adjustable.

The anchor may be formed for use on a support surface, in which the anchor is formed from a material affording the anchor a weight and surface property that resist displacement of the anchor relative to the support surface within a stretching threshold of the elastic chord.

The ball training apparatus may include an anchoring accessory for anchoring the anchor to a substrate, such as the ground. The anchoring accessory may be in the form of an auger tool. The auger tool may have a handle and a stem extending from the handle. A free end of the stem may be sharpened so that the stem can initially be inserted into the substrate. An auger formation may be arranged on the stem so that the stem can be screwed into the substrate.

The anchor may define an opening through which the stem of the auger can be passed prior to screwing the stem into the substrate.

The anchor may include a base. The base may include a chord fastening formation for fastening the chord to the base. The base may have an opening through which the end of the cord can be threaded to allow the cord to be tied to the base.

The base may also define a cord-retaining formation that is formed to facilitate winding of the cord onto the base. Furthermore, the cord-retaining formation may be formed so that a length of the cord or the effective length of the cord extending from the base can be adjusted.

The base may have a ball support for supporting the ball in at least one of a kicking and striking position.

The ball support may include a kicking ball support formation that is defined by the base, so that the ball can be supported in a kicking position on the base. Instead, the ball support may include a kicking ball support accessory that is mountable on the base to support the kicking ball in the kicking position. It will be appreciated that at least part of the base may have a profile which is sufficiently low and flat to permit unobstructed kicking of the kicking ball when it is mounted on the kicking ball support formation or kicking ball support accessory on the base.

The ball support may include a strike ball support that is mountable on the base for supporting a ball at a suitable height for striking with a club, bat or the like. The strike ball support may include a post, and the base may define an opening into which a bottom end of the post can be received to support the post in an upright orientation.

The strike ball support may define a ball support formation at an upper end of the post to support a ball in a pre-strike position.

The strike ball support may be height-adjustable. For example, the post may have a lower post member that is telescopically arranged with respect to an upper post member, and a retainer for holding the lower post member and upper post member in their relative positions, so that the position of the upper and lower post members can be adjusted to adjust the height of the ball support formation above the base.

A kit for a ball training apparatus is provided, the kit comprising
a. an anchor;
b. a ball;
c. an elastic cord with one end capable of being fastened to the anchor; and
d. a fastener for fastening the ball to another end of the cord, the elastic cord being configured so that, when the ball is struck, the ball is capable of sufficient travel for a user to observe the flight of the ball and of returning to a position in which retrieval of the ball is facilitated.

The ball may be any one of the balls as defined above, and may include any one or more of the optional features as herein described and illustrated.

The anchor may include any one of the optional features as herein defined, described and illustrated.

The elastic cord may include any one or more of the optional features as herein defined, described and illustrated.

The fastener may include any one or more of the optional features as herein defined, described and illustrated.

There is provided a fastener for fastening a ball to an end of a cord, the ball being of the type having an outer sheath and an inflatable inner bladder, the fastener including:
a. a stop that is capable of being received between the sheath and the inner bladder, the cord being attachable to the stop.

The stop may be elongated and may have a transverse hinge so as to form two foldable portions that are capable of being folded to reduce a plan profile of the stop.

The stop may define an opening through the stop at the transverse hinge.

In one example, an end of the cord may be passed through the opening and knotted so that the end is inhibited from being pulled back through the opening. It follows that the knot can initially be pulled away from the opening to allow the stop to be folded such that the knot does not interfere with the stop. Thus, the stop is capable of being folded to reduce its plan profile.

There is provided a method of fastening a ball of the type having an outer sheath and an inflatable inner bladder to an end of a cord, the method including:
a. forming a hole in the outer sheath;
b. attaching an end of the chord to a stop that is capable of being received between the outer sheath and the inner bladder; and
c. inserting the stop through the hole in the outer sheath so that the stop is received between the sheath and the inner bladder.

The steps of the above method can take place in any order. For example, the end of the cord can be attached to the stop before or after the stop is inserted through the sheath.

The method may include forming a stop that is elongated and that has a transverse hinge so as to form two foldable portions that are capable of being folded to reduce a plan profile of the stop.

The method may include forming an opening through the stop at the transverse hinge, and passing an end of the cord through the opening, and stopping the end of the chord from being pulled back through the opening.

Stopping the end of the chord from being pulled back through the opening may include forming a knotted end of the chord.

The method may include inserting the stop through the opening in the outer sheath while the inner bladder of the ball is at least partly deflated, pulling the chord so that the knot drives the folded portions apart so as to increase the plan profile of the stop, and inflating the inner bladder of the ball to sandwich the stop between the inner bladder and outer sheath of the ball.

The following description of the drawings is for illustrative purposes only and is not intended to narrow the scope of the preceding paragraphs or the appended claims.

### BRIEF DESCRIPTION OF THE DRAWINGS

FIG. 1 shows a plan view of one example of an anchor for a ball training apparatus.

FIG. 2 shows a side sectioned view through A-A in FIG. 1.

FIG. 3 shows a side sectioned view through B-B in FIG. 1.

FIG. 4 shows a side sectioned view through C-C in FIG. 1.

FIG. 5 shows a side view of one example of the ball training apparatus.

FIG. 6 shows a side view of another example of the ball training apparatus.

FIG. 7 shows a side view of an adjustable support post of the ball training apparatus of FIG. 6.

FIG. 8 shows a side view of one example of a stop forming part of a fastener of the ball training apparatus.

FIG. 9 shows a plan view of the stop of FIG. 8.

FIG. 10 shows a side view of a fastener that includes the stop of FIG. 8 that is folded prior to insertion through an opening in a ball.

FIG. 11 shows a side view of the fastener in FIG. 8 with its stop inserted through the opening in the ball.

FIG. 12 shows a schematic side sectioned view of the fastener in FIG. 8, in use, with its stop unfolded and sandwiched between an outer sheath and an inner bladder of the ball.

FIG. 13 shows a side sectioned view of another example of a fastener of the ball training apparatus.

FIG. 14 shows the anchor member of FIG. 13, in use.

FIG. 15 shows part of a cord of the ball training apparatus.

FIG. 16 shows a side view of an anchoring accessory of the ball training apparatus.

FIG. 17 shows a side sectioned view of another example of a fastener.

FIG. 18 shows part of string or cord for use in forming a loop for a fastener.

FIG. 19 shows part of another string or cord for use in forming a loop for a fastener.

FIG. 20 shows a three-dimensional view of an example of an anchor for the training apparatus.

FIG. 21 shows a three-dimensional view of the anchor of FIG. 20 in a partially folded over condition subsequent to a user striking a ball support mounted on the anchor.

FIG. 22 shows a three-dimensional view of another example of an anchoring accessory.

FIG. 23 shows a side elevation view of a part of a coupling that forms part of the anchoring accessory in FIG. 22.

FIG. 24 shows in side elevation view a section of part of a coupling that forms part of the anchor in FIG. 21.

FIG. 25 shows in side elevation view a section of part of a coupling that forms part of another anchoring accessory (not shown).

FIG. 26 shows another example of a fastener of the ball training apparatus.

FIG. 27 shows a head portion of another anchoring accessory.

### DETAILED DESCRIPTION OF THE INVENTION

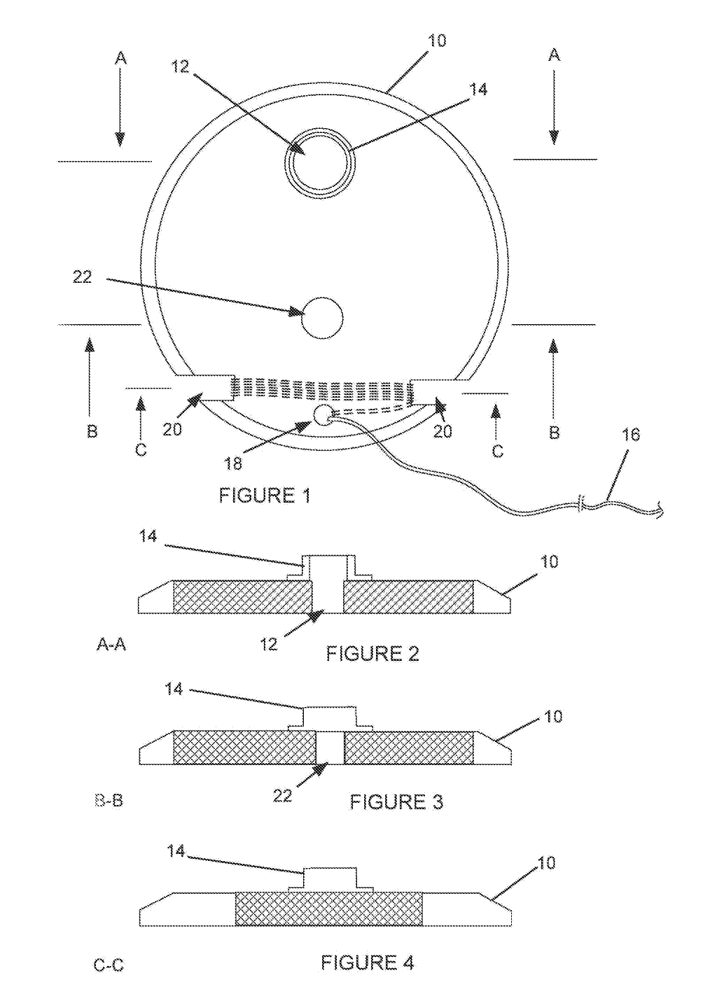

In FIG. 1 reference numeral 10 generally indicates a base for a ball training apparatus or for a kit for a ball training apparatus.

The base is in the form of a free standing member. The base 10 is generally circular in plan, but can be of any other suitable shape. In this example, the base 10 is disc-shaped.

The base 10 defines a passage 12. A ball support in the form of a kicking ball support formation 14 is mounted on the base 10 and is configured to support a ball in a pre-kicking position. The kicking ball support formation 14 is in the form of a flanged tube mounted co-axially with respect to the passage 12. A free end of the tube 14 is dimensioned so that the ball can be supported on the tube 14.

A cord in the form of an elastic cord 16 is fastened at one end to the base 10. The base 10 defines an opening 18 to permit the elastic cord 16 to be tied to the base 10 at one end. The other end of the cord 16 is secured to the ball, as discussed in more detail below.

The base 10 defines a pair of opposite slots 20, so as to define a cord-retaining formation. The slots 20 are located close to the opening 18 so that the cord 16 can be wound around the base 10, as indicated with the dotted lines in FIG. 1. Thus, the cord 16 can be stored when not in use. Alternatively, a length of the cord 16 that is played out can be altered, if required.

The cord 16 can be of natural or synthetic rubber, including latex rubber or any other material with similar properties. For example, the cord 16 can be of a material similar to that used for surgical tubing. For example, the material can be synthetic latex selected from one of styrene-butadiene rubber, acrylonitrile butadiene styrene, acrylic polymers, and polyvinyl acetate. The cord 16 is tubular so that the cord 16 can have less weight than a solid cord of similar dimensions with similar elastic properties. The outer diameter of the cord is between approximately 3 mm and 5 mm while an inner diameter of the cord 16 is between approximately 2 mm and 4 mm. Also, the cord is between about 3 m and 10 m long. However, this length can vary depending on the application. Also, when the cord 16 is wound about the base, it can be longer than 10 m.

The base 10 defines an anchor opening 22. The anchor opening 22 allows an anchoring accessory 24 (FIG. 16) to be received through the base 10 to anchor the base 10 to a substrate. In this embodiment, the anchoring accessory 24 is in the form of an auger tool 24. The tool 24 has a handle 26 and a stem 28 extending from the handle 26. An auger formation 30 is arranged on the stem 28. The stem 28 has a sharpened end 32 to allow the stem initially to be driven into the ground. The handle 26 is then rotated to drive the tool into the ground until the handle 26 abuts the base 10 to secure the base 10 in position. The auger tool can be of any suitable material, such as a metal or a plastics material. For example, the tool 24 can be of a reinforced plastics material which is suitably lightweight to facilitate carrying of the tool 24 together with the base 10.

The base 10 can be fabricated from a material with sufficient density to provide an anchoring effect without need for the tool 24. For example, the base 10 can be fabricated from a high density foam rubber material or any other material which is convenient to handle. For example, the base 10 can be fabricated from particulate recycled tyre rubber. The base 10 can be fabricated from a material with a density such that the base 10 can be carried within a sports bag or the like. It follows that the material can be flexible to permit the base 10 to be folded and stored.

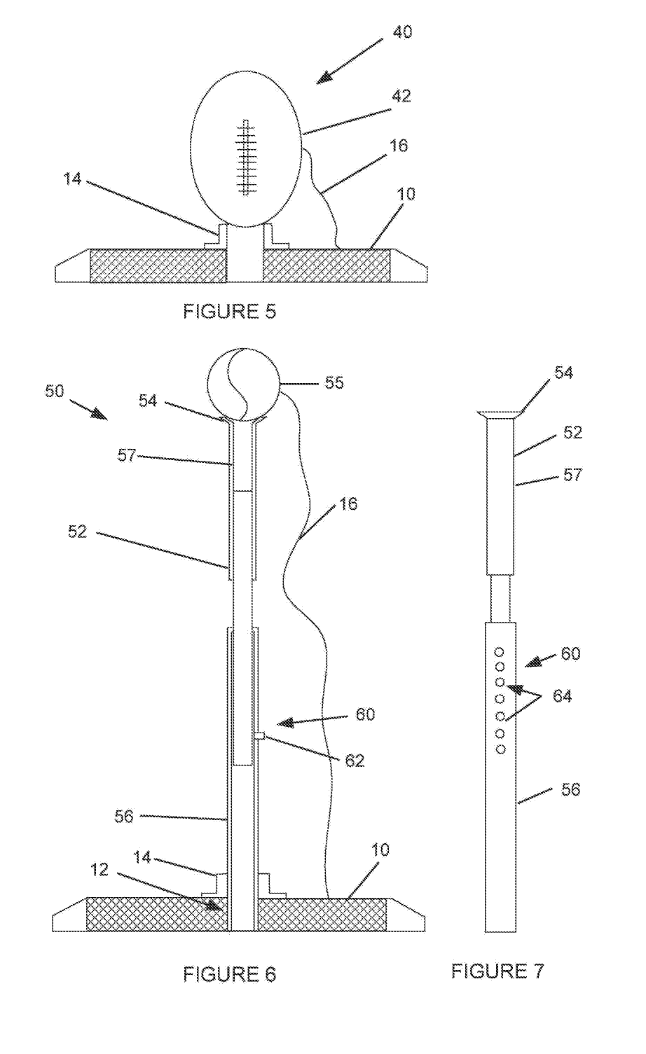

In FIG. 5, reference numeral 40 generally indicates the ball training apparatus for use with balls suitable for kicking. These could include soccer balls, rugby balls or NFL balls, or the like. As can be seen in FIG. 5, a ball 42 is supported on the tube 14.

In FIG. 6, reference numeral 50 generally indicates the ball training apparatus for use with balls suitable for striking with a club, bat or the like. The ball training apparatus 50 includes a ball support in the form of an elongate support post 52 that has a lower end that is received in the passage 12. A ball support formation 54 is arranged on an upper end of the post 52 and is configured for supporting a ball 55. The ball support formation 54 can be in the form of a frustoconical, tubular member. The frustoconical member can be of an elastomeric material. Other formations, such as an array of flexible spikes to form a brush, can also be suitable. The passage 12 and the support post 52 are dimensioned so that the support post 52 is a snug fit in the passage 12. This allows the support post 52 to be pulled from and inserted into the passage 12.

A length of the support post 52 is adjustable to suit various strike heights. Thus, the support post 52 has a lower post member 56 and an upper post member 58. The members 56, 58 are telescopically arranged with respect to each other so that an overall length and thus height of the support post 52 can be adjusted by displacing the members 56, 58 relative to each other. An adjustment mechanism 60 is arranged between the members 56, 58 to facilitate the adjustment of the members 56, 58 with respect to each other in a releasable manner. The adjustment mechanism 60 includes a spring-mounted locking member or pin 62 mounted on the lower member 56 to be displaced, against a bias, into the locking member. The mechanism 60 also includes a series of openings 64 extending along the upper member 58. In use, the pin 62 can be depressed and the upper member can be positioned so that either one of the openings 64 is aligned with the pin 62 before the pin 62 is released.

Instead, and as can be seen in FIG. 21, the support post 52 can have a configuration similar to that used for telescopic camera supports. For example, the support post 52 can have a number of telescopically arranged members 51. Suitable clamp members 53 can be provided to lock the members 51 relative to each other at a desired height. In this embodiment, the frustoconical member 54 can be urged onto an operatively upper end of the uppermost member 51.

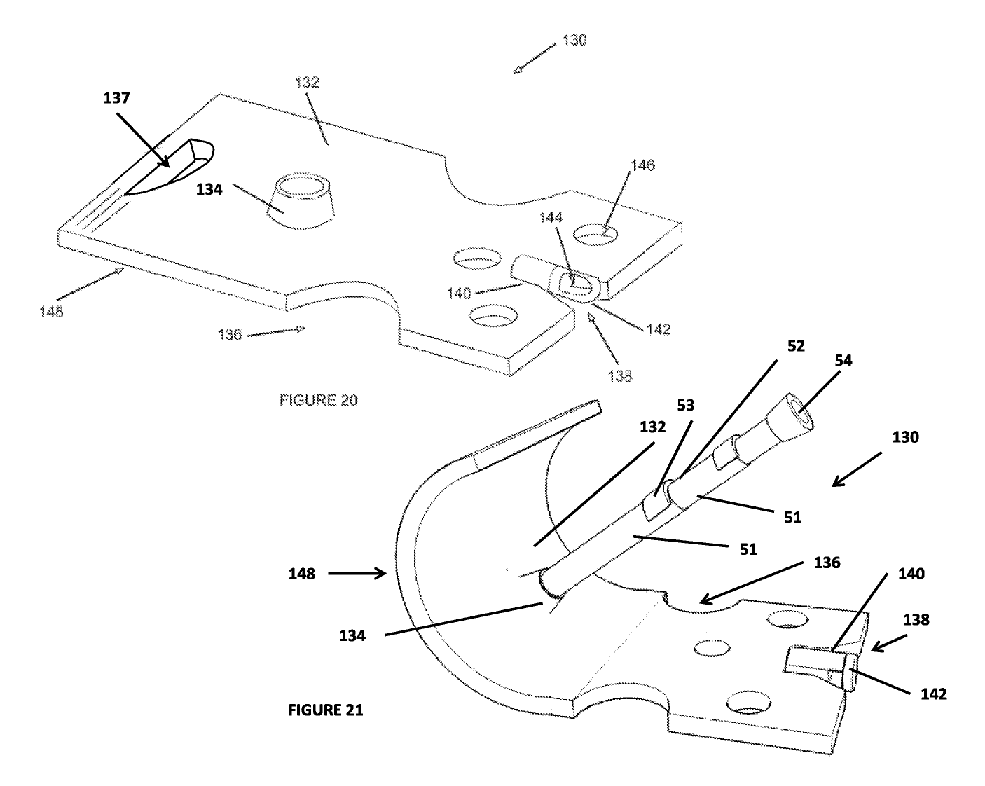

FIG. 20 shows another embodiment of an anchor 130. The anchor 130 includes a base 132 in the form of a generally flat mat formed from a rubber material, such as rubber particles from recycled tyres, for example. Such material is often bonded together to form playground surfaces and the like. The mat 132 can be formed from other materials such as high density expanded material. The mat 132 is generally rectangular in plan view and low in profile. For example, the mat 132 can have a length of between 300 mm and 600 mm and a width of between about 200 mm and 400 mm. A thickness of the mat can be between about 8 mm and 15 mm. The mat 132 defines two laterally opposite recesses 136, so as to form a cord-retaining formation between them about which the cord 16 can be wound. The mat 132 also defines three circular holes 146 through which an anchoring accessory 24 can be passed into the supporting substrate. The holes 146 also serve to reduce the weight of the mat 132 while maintaining its functionality.

The mat 132 defines a handle opening 137 to facilitate carrying of the mat 132.

The base 132 further includes a formation 134 located on the base 132. The formation 134 is shaped and sized so that it is able to be used as a kicking ball support or as a socket for receiving an end of the support post 52. The formation 134 is positioned on the mat 132 at a position which facilitates lifting of a rear end portion 148 of the mat 132 when the support post 52 is struck with a bat, or the like so that the mat 132 can fold over and return to its original position after being struck For example, a centre point of a socket of the formation 134 can be less than half way from that shorter side of the mat 132 which would be on an approach side of a ball mounted on the support post 52 to an opposite shorter side of the mat 132. For example, with the dimensions of the mat given above, the centre point of the socket can be between 100 mm and 300 mm from that approach shorter side of the mat. The position of the formation 134 is such that when the ball is missed and the post 52 is struck, the mat can bend forward as shown in FIG. 21. The mat 132 then tends to move back into the pre-strike position at a speed that avoids injury that could be caused by a post snapping back or a bat bouncing off the post. This can also occur if the ball is not struck correctly.

The anchor 130 further includes a coupling 138 that is fixed towards one end of the base 132 in a manner in which the coupling is partly received within a V-shaped notch that is defined by a shorter side of the base 132 opposite the approach side. The coupling 138 includes one coupling member 140 that is fixed to the mat 132, and another coupling member 142 for cooperating with the coupling member 140. The coupling member 140 includes a mushroom-shaped coupling formation 174 (FIG. 23) that is received within a cavity 176 that is defined by the other coupling member 142, so that the coupling members 140, 142 are able to swivel (see arrow 172) relative to each other. The other coupling formation 142 defines a passage or opening 144 so that a cord or a loop for attachment to a cord can be connected to the mat 132, while being freely rotatable with respect to the mat 132. As mentioned above, this inhibits winding up and subsequent entanglement of the cord 16.

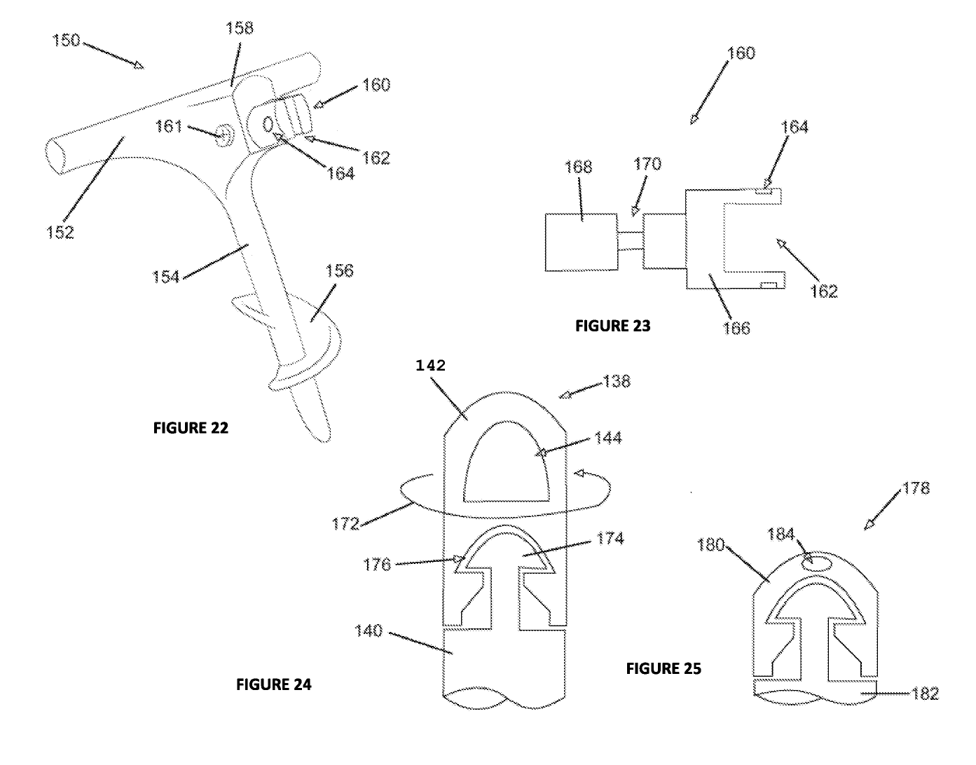

FIG. 22 shows an anchoring accessory 150 that includes an auger tool having a head 152 and a nose formation 158 projecting away from the head 152, a stem 154 projecting from the head 152 and screw formations 156 on the stem 154. The nose formation 158 defines a socket or recess into which a coupling member 160 projects so as to form a coupling to which the cord 16 is attachable. It follows that the anchor accessory 150 can be used to anchor the cord 16 or to anchor a base such as the mat 132.

The coupling member 160 includes a cylindrical stem 168 that defines an annular recess 170. The stem 168 is inserted into the socket or recess defined by the nose formation 158, and a screw 161 projects through the nose formation into the annular recess 170. That way, the coupling member 160 is retained in the nose formation 158 and is able to swivel relative to the nose formation 158 as shown by arrow 172. As before, this helps to avoid winding up and subsequent entanglement of the chord 16.

The coupling member 160 also includes a head 166 that defines opposite prong-like formations through which holes 164 extend for attaching the chord 16 or a loop for attaching the cord 16.

FIG. 24 shows a coupling 178 for another embodiment of an anchoring accessory (not shown) or for the anchoring accessory 150. The coupling 178 includes an inner coupling formation 182 that can be integrally formed with a nose portion of an auger tool part (not shown) of the anchoring accessory (not shown). The coupling 178 also includes an outer coupling member 180 which defines a cavity within which a formation of the inner coupling member 182 is received in a manner that retains the inner coupling member 182 and that permits swiveling relative to the inner coupling member 182.

FIG. 27 shows part of another anchoring accessory 198 which includes a head 200 and a stem 202. The anchoring accessory 198 defines a hole 204 for connecting the cord 16 or a loop for the cord 16.

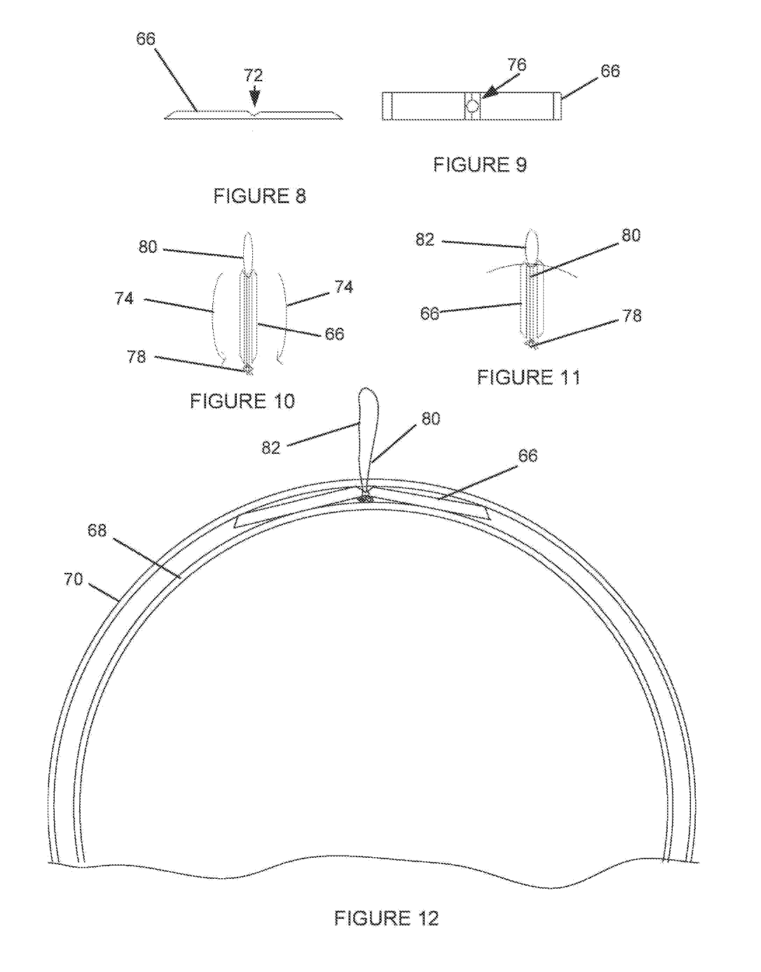

In FIGS. 8 to 12, there is shown a fastener including a stop 66 for anchoring the cord 16 to a ball of the type having an internal bladder 68 and an external sheath 70. The ball 42 referred to above is an example of such a ball.

The stop 66 is elongate and defines a transverse hinge so that it is capable of being folded to reduce its profile significantly. In this example, the stop 66 is in the form of a strip of a plastics material. For example, the stop 66 can be a strip of plastics material which is between about 40 mm and 50 mm long, 4 mm and 10 mm wide, and 1 mm and 3 mm thick. A transversely extending V-shaped recess 72 is defined about halfway along the length of the strip 66. The recess 72 defines a zone of weakness to allow the stop 66 to be folded in the direction indicated by the arrows 74 in FIG. 10. Each end of the stop 66 is tapered so that when the stop 66 is folded, as indicated, the ends together define a reduced cross-sectional area.

An opening 76 is defined in the stop 66 at the recess 72. A length of string 80 is folded over and its ends received through the opening and tied together into a knot 78 on that side towards which the stop 66 is folded. It will be appreciated that the string 80 thus forms a loop 82 on an opposite side of the stop 66.

Initially, the knot 78 is pulled away from the stop 66 to allow the stop 66 to be completely folded with the string interposed between portions of the stop 66 and the knot 78 located at the ends of the stop 66.

The knot 78 and the ends are then inserted through an opening in the sheath 70 until the stop 66 is received within the sheath 70 with the loop 82 extending from the sheath 70. The sheath 70 can either be supplied with the opening or a user can form the opening with a suitable tool. Once the stop is received through the sheath 70, the loop 82 can be pulled so that the knot 78 is pulled between the portions of the stop 66 thereby driving the portions apart and preventing the stop from being withdrawn back out of the opening. The cord 16 is then tied to the loop 62.

When the bladder 68 is inflated, the stop 66 is interposed between the bladder 68 and the sheath 70 so that the stop 66 is inhibited from folding and being withdrawn from the opening in the sheath 70.

Instead of using the string 80, the cord itself can simply be passed through the opening 76 and knotted.

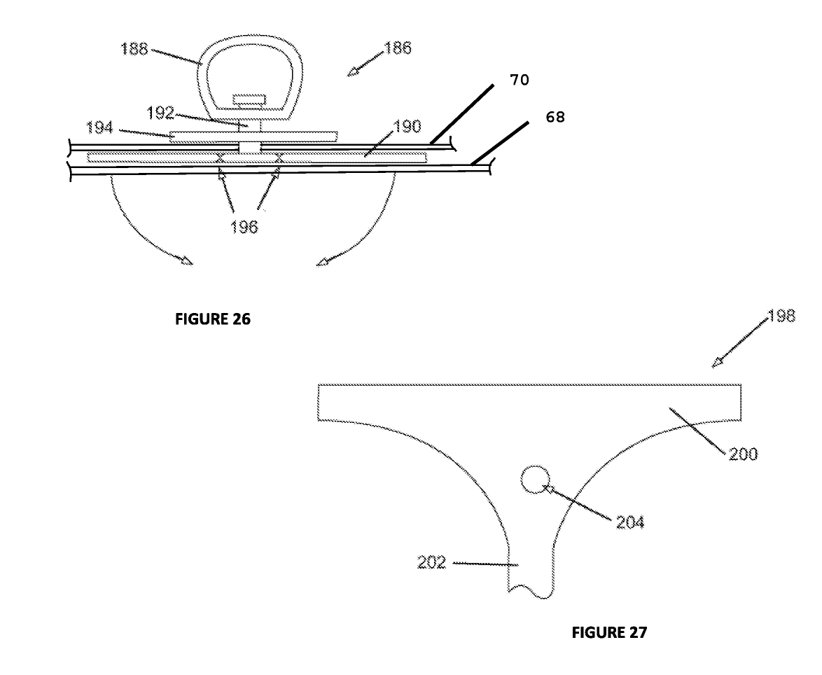

FIG. 26 shows another embodiment of a fastener 186. The fastener 186 includes a stop 190 that is fixed to a stub or pivot pin 192. The stop 190 has similar dimensions to the stop 66. The stop 190 and the pivot pin 192 can be integrally formed. For example, the stop 190 and the pivot pin 192 can be in the form of a one-piece moulding. The stop 190 has two hinges 196 so that the pivot pin 192 is interposed between the hinges 196. A washer 194 is arranged on the pivot pin 192. A loop 188 is mounted and retained on the pivot pin 192 so that the loop 188 can swivel about the stub 192. Thus, the winding up and subsequent entanglement of the cord 16 can be alleviated.

As before, portions of the stop 190 are pivoted towards each other in the direction of the arrows so that the stop 190 can fit through an opening in the sheath 70. The opening can be made by piercing the sheath 70 when the bladder 68 is deflated. When the bladder 68 is inflated, the portions pivot away from each other and the stop 190 is interposed between the bladder 68 and the sheath 70 as shown in FIGS. 12 and 26. Thus, a portion of the sheath 70 is interposed between the stop 190 and the washer 194. The pressure in the bladder 68 inhibits the portions from pivoting towards each other and being retracted from the opening in the sheath 70.

The pivot pin 192 and the loop 188 can be of a material which is sufficiently soft and flexible to minimise interference with a kick that may strike the loop 188. The loop 188 can also be in the form of a loop of string or cord to which the cord 16 can be attached.

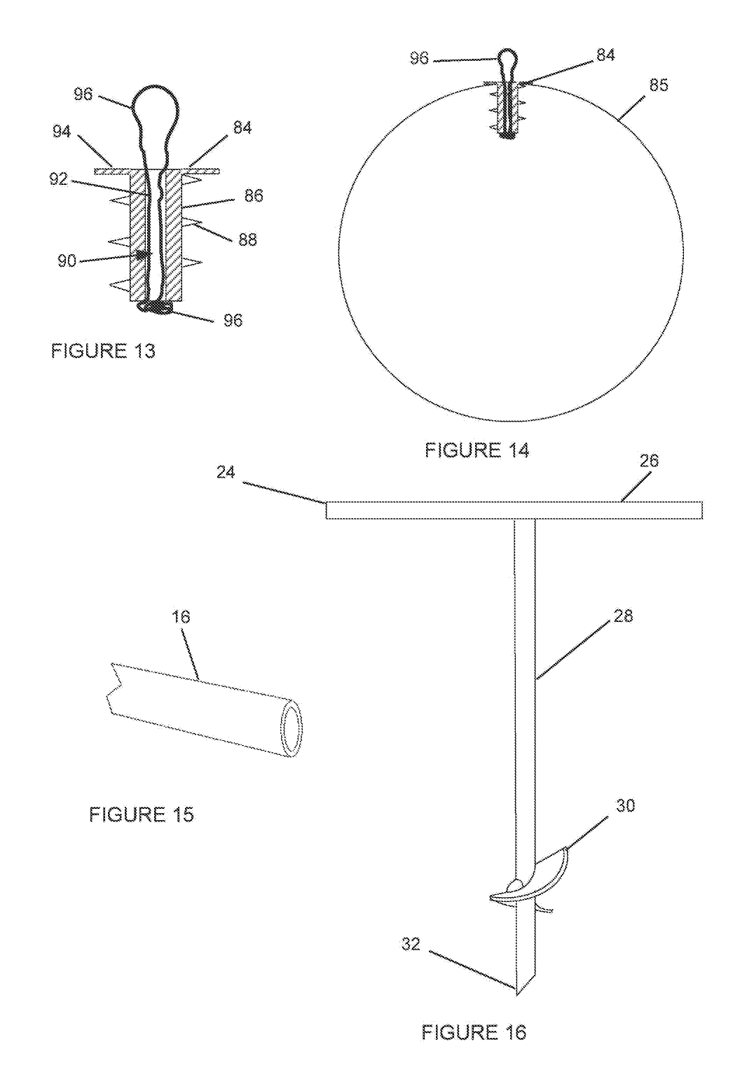

In FIGS. 13 and 14, there is shown a fastener including an anchor member 84 suitable for use with a ball 86 having a solid core. The ball 55 is an example of such a ball.

The anchor member 84 has a plug 86 with an external self-tapping thread 88. The plug 86 defines a longitudinal passage 90. The plug 86 has a flange 94 at its proximal end. The proximal end of the plug 86 is configured so that a tool can engage the proximal end and can be rotated to drive the plug 86 into the ball 85, as shown in FIG. 14.

A string 92 is folded over and its ends inserted through the passage 90 from the proximal end of the passage 90 to the distal end. The ends are then tied together to form a knot 96 so that the string 92 is prevented from being withdrawn from the passage 90. The string 92 is of sufficient length so that a loop 96 is formed outside the proximal end of the passage 90. The plug 86 is then screwed into the ball 85. The cord 16 can be tied to the loop 96 to secure the cord 16 to the ball 85.

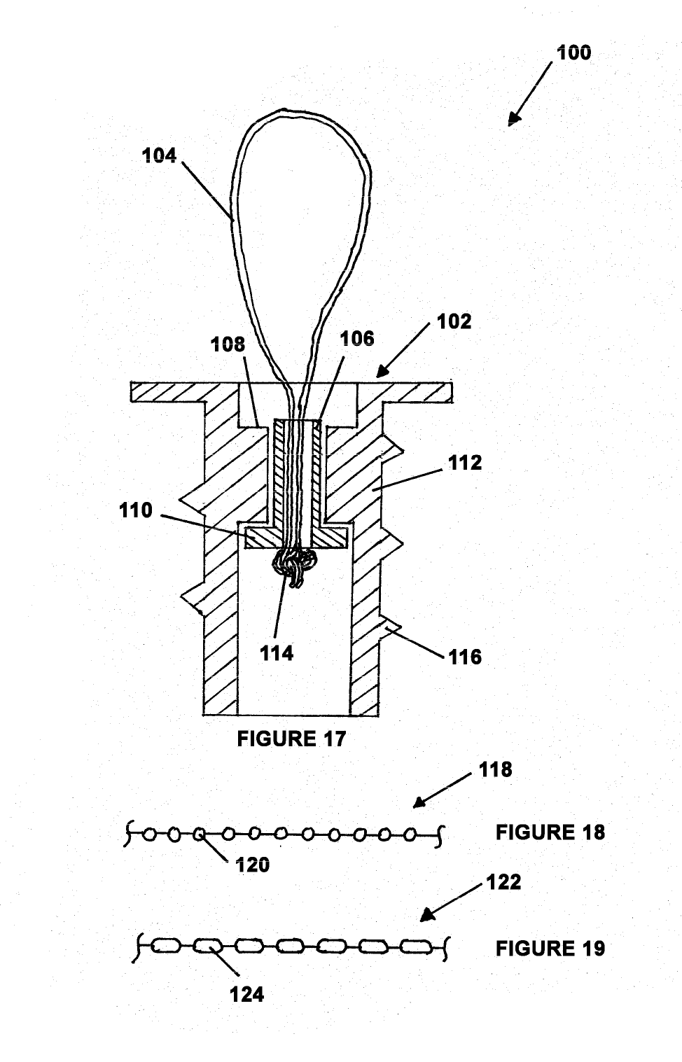

FIG. 17 shows another embodiment of a fastener 100 for use with a ball having a substantially solid core. The fastener 100 includes a swivel plug 102 which includes an inner plug member 106 and an outer plug member 112 that are retained relative to each other in a manner that permits swiveling relative to each other.

The inner plug member 106 is tubular so that the cord 16 can be passed through the inner plug member 106 and knotted, see knot 114, so that the end is inhibited from being pulled back through the plug member 106. The inner plug member 106 also includes a flange 110 at one end.

The outer plug member 116 is also tubular, and defines an inner collar 108 for cooperating with the inner flange 110 to resist the inner plug member 106 from being pulled out through the outer plug member 112. The outer member includes a screw-thread 116.

FIG. 18 shows a piece of string 118 that can be used to form a loop for an anchor member. The piece of string 118 includes spherical formations 120, for example appropriately sized beads, that are fixed on a flexible member. FIG. 19 shows another piece of string 122 that includes elongated generally cylindrical beads having rounded ends. The spherical formations or beads can serve to inhibit excessive wear of the strings 118, 120.

The length of the cord 16 together with its elastic characteristics allow the ball to be kicked or struck and to travel a sufficient distance to permit the user to view the flight of the ball. This allows the apparatus to be used as a training device for kicking or striking balls. Furthermore, the material of the cord 16 is such that the ball can return at least to an area close to the user so that the kick or strike can be repeated with a minimum amount of inconvenience to the user.

The cord 16 can have a significantly greater length for different applications, for example, where a ball would usually travel greater distances. In that case, the slots or formations 20, 136 in the base or mat 10, 132 can be used to adjust a length of the cord 16 to suit different applications. This can simply be done by winding a required amount of the cord 16 onto the base or mat 10, 132 in the slots or formations 20, 136.

It is to be noted that the base 10 is interchangeable with the mat 132 in the apparatus 50.

It is possible for a user to make use of a conventional ball by simply piercing the sheath 70 with a suitable tool. It will be appreciated that, since the required opening can be relatively small when compared with the ball as a whole, the damage to the sheath 70 will be minimal. This allows a user subsequently to remove the stop 66, 190, when the bladder 68 is deflated, so that the ball can be used in a conventional manner. This allows the users to become familiar with a ball which would usually be used competitively or at least in training.

The inventor believes that the invention will be particularly popular with children as it incorporates a significant entertainment factor.

The auger tool 24 allows the base 10 to be secured to the ground without the need for a hammer and a peg. Thus, the apparatus can be used by children without the fear of injury that would be associated with the use of a hammer.

The apparatus can readily be stored in a sports bag in its kit form. This is facilitated in the case of the apparatus 50 since the lower and upper post members 56, 58 can be disassembled. Thus, transport of the apparatus to a desired training area is facilitated.

The base may be formed from a material that has a density which is such that the base can be placed in a sports bag while still having sufficient weight to perform its function as an anchor.

Various substantially and specifically practical and useful exemplary embodiments of the claimed subject matter are described herein, textually and/or graphically, including the best mode, if any, known to the inventor for carrying out the claimed subject matter. Variations (e.g., modifications and/or enhancements) of one or more embodiments described herein might become apparent to those of ordinary skill in the art upon reading this application. The inventor expects skilled artisans to employ such variations as appropriate, and the inventor intends for the claimed subject matter to be practiced other than as specifically described herein.

Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the claimed subject matter.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:
a. there is no requirement for the inclusion of any particular described or illustrated characteristic, function, activity, or element, any particular sequence of activities, or any particular interrelationship of elements;
b. any elements can be integrated, segregated, and/or duplicated;
c. any activity can be repeated, any activity can be performed by multiple entities, and/or any activity can be performed in multiple jurisdictions; and
d. any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate sub range defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

What is claimed is:

1. A ball training apparatus comprising:
an elastic cord; and
a fastener capable of being at least partially received between a bladder and a sheath of an inflatable ball, the fastener being configured to permit an end of the elastic cord to be attached to the fastener, the elastic cord being configured so that, when the ball is struck, the ball is capable of sufficient travel for a user to observe the flight of the ball and of returning to a position in which retrieval of the ball is facilitated.

2. The ball training apparatus as claimed in claim 1, in which the fastener includes a stop that is elongated and hinged to define two portions that are capable of pivoting towards each other to reduce a plan profile of the stop to facilitate insertion of the stop through an opening in the sheath so that subsequent pivoting away from each other serves to resist extraction of the stop from the opening.

3. The ball training apparatus as claimed in claim 2, in which the fastener includes a connector attached to the stop at a position about halfway along the length of the stop and between said portions, the connector extending through the opening in the sheath for connection to the cord.

4. The ball training apparatus as claimed in claim 3, in which the connector is a swivel connector so that twisting of the cord and subsequent entanglement resulting from rotation of the ball relative to the cord is reduced.

5. The ball training apparatus as claimed in claim 4, in which the swivel connector includes a pivot pin that extends from the stop, a looped connector being mounted on the pivot pin and rotatable with respect to the pivot pin.

6. The ball training apparatus as claimed in claim 2, in which the stop is configured so that, when the bladder is inflated, the portions of the stop are driven apart further to secure the stop between the bladder and the sheath.

7. The ball training apparatus as claimed in claim 1, which includes an anchor for use on a support surface, the anchor being formed from a material affording the anchor a weight and surface property so as to resist displacement of the anchor relative to the support surface within a stretching threshold of the elastic chord.

8. The ball training apparatus as claimed in claim 7, which includes an anchoring accessory for anchoring the anchor to a substrate.

9. The ball training apparatus as claimed in claim 8, in which the anchoring accessory is in the form of an auger tool having a handle and a stem extending from the handle, a free end of the stem being sharpened so that the stem is able to be inserted into the substrate, an auger formation being arranged on the stem so that the stem can be screwed into the substrate.

10. The ball training apparatus as claimed in claim 9, in which the anchor defines an opening through which the stem of the auger can be passed prior to screwing the stem into the substrate.

11. The ball training apparatus as claimed in claim 10, in which the anchor includes a base with an opening through which the end of the cord can be threaded to allow the cord to be tied to the base and a cord-retaining formation to facilitate winding of the cord onto the base.

12. The ball training apparatus as claimed in claim 11, in which the base defines a kicking ball support formation so that the ball can be supported in a kicking position on the base.

13. The ball training apparatus as claimed in claim 12, which includes a strike ball support that is mountable on the base for supporting a ball at a suitable height for striking.

14. A ball training apparatus comprising:
an inflatable ball having an inflatable bladder located within a sheath;
an elastic cord; and
a fastener at least partially received between the bladder and the sheath, an end of the elastic cord attached to the fastener, the elastic cord being configured so that, when the ball is struck, the ball is capable of sufficient travel for a user to observe the flight of the ball and of returning to a position in which retrieval of the ball is facilitated.

15. A method of fastening an elastic cord to an inflatable ball having an inflatable bladder located with a sheath, the method comprising:
forming an opening in the sheath;
inserting a fastener at least partially through the opening;
attaching the elastic cord to the fastener; and
inflating the bladder.
